(19) United States
(12) Patent Application Publication
(10) Pub. No.: US 2012/0122509 A1
(43) Pub. Date: May 17, 2012

(54) RADIO BASE STATION AND COMMUNICATION CONTROL METHOD

(75) Inventor: Taku Nakayama, Kanagawa (JP)

(73) Assignee: KYOCERA CORPORATION, Kyoto (JP)

(21) Appl. No.: 13/387,699

(22) PCT Filed: Jul. 28, 2010
(86) PCT No.: PCT/JP2010/062721

§ 371 Date: Jan. 27, 2012

(30) Foreign Application Priority Data
Jul. 28, 2009 (JP) 2009-175605

(51) Int. Cl. H04W 72/08; H04W 52/04; H04W 24/02

(52) U.S. Cl. 455/513

(57) ABSTRACT

When estimating the quality (SINR) of a PDCCH corresponding to a local sector formed by a radio base station (1A), a control unit (102) in the radio base station (1A) confirms the status of a response from a radio terminal (2A) in reply to control information sent using the PDCCH to the radio terminal (2A). The radio base station (1A) corrects a reference SINR in accordance with the aforementioned response status, thereby obtaining an estimated value (estimated PDCCH-SINR).

### TECHNICAL FIELD

The present invention relates to a radio base station configured to communicate with a radio terminal by allocating radio resource corresponding to a predetermined cell or sector to the radio terminal, the radio resource including control information transmission radio resource and user data transmission radio resource, and also relates to a communication control method for the radio base station.

### BACKGROUND ART

The recent growth of broadband mobile communication services has created a demand for further increase in speed and capacity. For this reason, a next generation mobile communication system is just started to be put to practical use worldwide as an alternative to the third generation mobile communication system or 3.5th generation mobile communication system typified by W-CDMA (Wideband Code Division Multiple Access). In Japan, there has been started frequency allocation to the 3.9th generation mobile communication system regarded as a mobile communication system that leads to the fourth generation mobile communication system. Among these 3.9th generation mobile communication systems, LTE (Long Term Evolution) is considered most potent as the standard leading to the fourth generation mobile communication system.

In the LTE, OFDMA (Orthogonal Frequency Division Multiplexing Access) is used for downlink communication from a radio base station to a radio terminal and SC-FDMA (Single Carrier Frequency Division Multiple Access) is used for uplink communication from the radio terminal to the radio base station. These multiplexing schemes implement user multiplexing by allocating radio resource in two dimensions, frequency and time.

A frequency band that is a downlink radio resource is divided into units called resource blocks (RBs). The RB includes a PDCCH (Physical Downlink Control CHannel) that is a time slot as a radio channel for transmitting downlink control information and a PDSCH (Physical Downlink Shared CHannel) that is a time slot as a radio channel for transmitting downlink user data.

### PRIOR ART DOCUMENT

### Non-Patent Document

Non-patent document 1: 3GPP TS 36.213 V8.4.0 “Technical Specification Group Radio Access Network: Evolved Universal Terrestrial Radio Access (E-UTRA); Physical Layer procedures (Release 8)”
Non-patent document 2: 3GPP TS 36.211 V8.4.0 “Technical Specification Group Radio Access Network: Evolved Universal Terrestrial Radio Access (E-UTRA); Physical Channels and Modulation (Release 8)”

### SUMMARY OF THE INVENTION

In order to achieve increase in speed and capacity, the LTE requires much higher frequency usage efficiency than the conventional third generation mobile communication system or 3.5th generation mobile communication system. To meet such a requirement, the LTE is assumed to operate using the same frequency in adjacent cells or sectors. Such an operation may have a problem that a certain cell or sector suffers interference from another cell or sector.

For this reason, the radio base station needs to grasp the qualities (SINR) of the PDSCH and PDCCH in the radio terminal, which vary with the interference, and to perform communication control so that the qualities meet the required level. The information transmitted through the PDCCH, in particular, includes various kinds of control information required to receive the information transmitted through the PDSCH. Thus, the radio terminal needs to normally receive the control information transmitted using the PDCCH. To realize such normal reception, it is important that the radio base station performs control so that the PDCCH quality meets the required level.

However, under the LTE standards, the radio terminal transmits only the PDSCH quality and does not transmit the PDCCH quality to the radio base station. For this reason, the radio base station sometimes performs the control so that the PDCCH quality meets the required level while considering the PDSCH quality from the radio terminal to be the PDCCH quality. However, the utilization rate of the PDCCH radio resource is generally lower than the utilization rate of the PDSCH radio resource. Accordingly, the PDCCH is less likely to suffer interference from another cell or sector. For this reason, if the PDSCH quality is regarded as the PDCCH, the PDCCH quality is estimated to be excessively low. This leads to a problem that the number of repetitions of transmission of the same information is increased and the radio resource is used more than necessary, for example. To prevent such a problem, it is required to properly estimate the PDCCH quality in the radio terminal.

Therefore, it is an objective of the present invention to provide a radio base station and a communication control method, which are capable of properly estimating the quality of radio resource.

The present invention has the following features to solve the problems described above. First of all, a first feature of the present invention is summarized as a radio base station (radio base station 1A, radio base station 1B, radio base station 1C) forming a predetermined cell or sector and communicating with a radio terminal (radio terminal 2A, radio terminal 2B, radio terminal 2C) by allocating radio resource corresponding to the predetermined cell or sector to the radio terminal, the radio resource including control information transmission radio resource and user data transmission radio resource, comprising: an estimation unit (SINR estimation unit 158) configured to calculate a value obtained by correcting a reference value of the quality of the control information transmission radio resource as an estimated value of the quality of the control information transmission radio resource in accordance with the status of a response from the radio terminal, the response corresponding to control information transmitted to the radio terminal using the control information transmission radio resource.

The radio base station as described above obtains an estimated value by correcting a reference value in accordance with the status of a response from the radio terminal in estimating the quality of the control information transmission radio resource included in predetermined downlink radio resource corresponding to the predetermined cell or sector formed by the radio base station.

The radio base station performs communication control so that the quality of the control information transmission radio resource meets the required level. In such a case, the status of the response from the radio terminal that is a destination of the control information shows whether the quality of the control information transmission radio resource understood by the radio base station is satisfactory or not. The response status also serves as information useful for the radio base station to estimate the quality of the control information transmission radio resource.

Thus, the quality of the control information transmission radio resource required for communication control can be properly estimated by the radio base station estimating the quality of the control information transmission radio resource in accordance with the status of the response from the radio terminal.

A second feature of the present invention is summarized as the radio base station in the first feature of the present invention, wherein the estimation unit calculates a value smaller than the reference value as the estimated value of the quality of the control information transmission radio resource if the status of the response from the radio terminal is not normal, and calculates a value larger than the reference value as the estimated value of the quality of the control information transmission radio resource if the status of the response from the radio terminal is normal.

A third feature of the present invention is summarized as the radio base station in the second feature of the present invention, wherein the estimation unit determines a ratio of increment and decrement from the reference value when obtaining the estimated value, based on a target value of an error rate of data transmitted using the control information transmission radio resource.

A fourth feature of the present invention is summarized as the radio base station according to any of the first to third feature of the present invention, wherein the reference value is the quality of the user data transmission radio resource.

A fifth feature of the present invention is summarized as the radio base station according to any of the first to third feature of the present invention, wherein the control information is at least any of allocation information of downlink user data transmission radio resource, allocation information of uplink user data transmission radio resource, and a transmission power control command.

A sixth feature of the present invention is summarized as a communication control method for a radio base station forming a predetermined cell or sector and communicating with a radio terminal by allocating radio resource corresponding to the predetermined cell or sector to the radio terminal, the radio resource including control information transmission radio resource and user data transmission radio resource, the method comprising the step of: calculating, by the radio base station, a value obtained by correcting a reference value of the quality of the control information transmission radio resource as an estimated value of the quality of the control information transmission radio resource in accordance with the status of a response from the radio terminal, the response corresponding to control information transmitted to the radio terminal using the control information transmission radio resource.

The present invention enables proper estimation of the quality of radio resource.

### BRIEF DESCRIPTION OF THE DRAWINGS

FIG. 1 is an overall schematic configuration diagram of a radio communication system according to an embodiment of the present invention.

FIG. 2 is a configuration diagram of a radio base station according to the embodiment of the present invention.

FIG. 3 is a diagram showing an example of PDSCH allocation by the radio base station according to the embodiment of the present invention.

FIG. 4 is a diagram showing an example of allocation of REGs in a PDCCH by the radio base station according to the embodiment of the present invention.

FIG. 5 is a flowchart showing a PDCCH quality estimation operation by the radio base station according to the embodiment of the present invention.

### DESCRIPTION OF THE EMBODIMENTS

Next, embodiments of the present invention are described with reference to the drawings. To be more specific, description is given of (1) Configuration of Radio Communication System, (2) Operations of Radio Base Station, (3) Advantageous Effects, and (4) Other Embodiments. In the description of the drawings in the following embodiments, the same or similar portions are denoted by the same or similar reference numerals.

### (1) CONFIGURATION OF RADIO COMMUNICATION SYSTEM

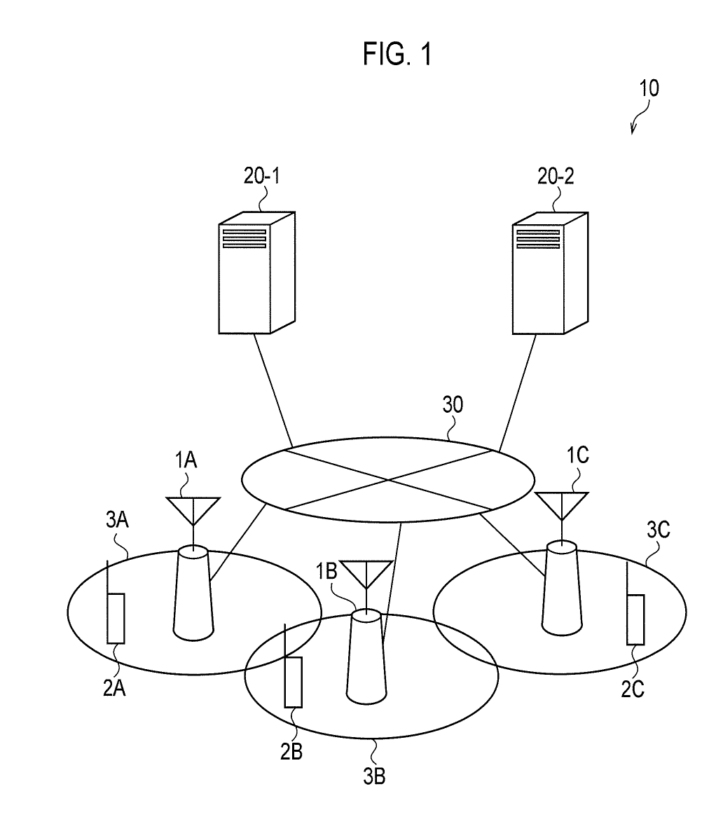

(1.1) FIG. 1 is an overall schematic configuration diagram of a radio communication system according to an embodiment of the present invention.

A radio communication system 10 shown in FIG. 1 has a configuration based on LTE (Long Term Evolution) that is the standard formulated by 3GPP. The radio communication system 10 includes: a radio base station 1A, a radio base station 1B and a radio base station 1C; a radio terminal 2A, a radio terminal 2B and a radio terminal 2C; an MME (Mobile Management Entity)/SGW (Serving Gateway) 20-1 and an MME/SGW 20-2, which are transfer control devices; and a backbone network 30.

In FIG. 1, the radio terminal 2A is present in a cell 3A formed by the radio base station 1A, the radio terminal 2B is present in a cell 3B formed by the radio base station 1B, and the radio terminal 2C is present in a cell 3C formed by the radio base station 1C. The cells 3A to 3C are divided into multiple sectors (not shown), respectively.

The radio base station 1A communicates with the radio terminal 2A present in the cell 3A. Similarly, the radio base station 1B communicates with the radio terminal 2B present in the cell 3B, while the radio base station 1C communicates with the radio terminal 2C present in the cell 3C.

Between the radio base stations 1A to 1C and the MME/SGWs 20-1 and 20-2, an S1 connection as a logical transmission path of a transport layer is established through the backbone network 30. Moreover, X2 connections as logical transmission paths of the transport layer are established between the radio base stations 1A to 1C through the backbone network 30.

(1.2) Configuration of Radio Base Station

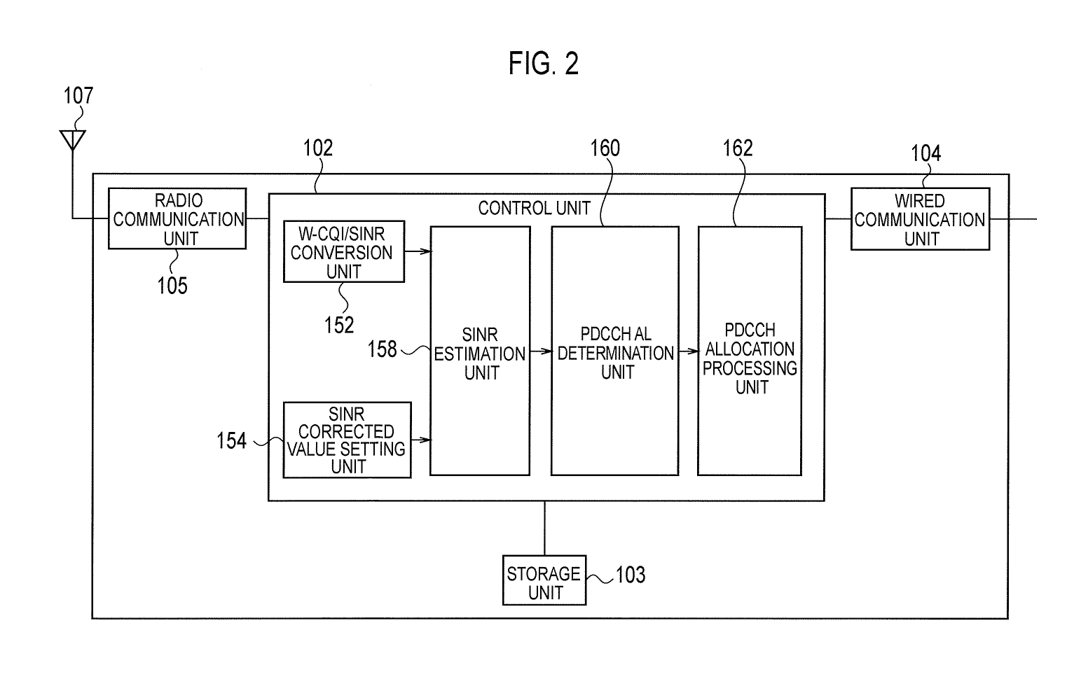

FIG. 2 is a diagram showing a configuration of the radio base station 1A. The radio base station 1A shown in FIG. 2 includes a control unit 102, a storage unit 103, a wired communication unit 104, a radio communication unit 105 and an antenna 107. Note that the radio base stations 1B and 1C also have the same configuration as that of the radio base station 1A.

The control unit 102 is formed of a CPU, for example, and controls various functions included in the radio base station 1A. The storage unit 103 is formed of a memory, for example, and stores various information used for control and the like in the radio base station 1A. The wired communication unit 104 is connected to the backbone network 30 through an unillustrated router or the like. The radio communication unit 105 receives a radio signal from the radio terminal 2A through the antenna 107, and transmits a radio signal to the radio terminal 2A.

Next, specific control by the control unit 102 is described. The control unit 102 allocates one or more resource blocks (RBs), which is downlink radio resource, to the radio terminal 2A according to channel quality requested by the radio terminal 2A present in a predetermined sector (herein after referred to as the “own sector”) included in the cell 3A formed by the radio base station 1A.

The RB is formed of two kinds of radio channels, more specifically, a control information channel (PDCCH) and a shared data channel (PDSCH). A PDCCH region includes at most three OFDM symbols from the top of the RB, while a PDSCH region includes OFDM symbols following the PDCCH. In this embodiment, the RBs to be allocated have consecutive frequency bands.

The channel quality requested by the respective radio terminals in the own sector differs from one another. The control unit 102 sets RBs to be allocated to the radio terminal and the number thereof, and also allocates the RBs to the radio terminal according to the channel quality requested by each of the radio terminals. To be more specific, the control unit 102 allocates the PDSCH and PDCCH in the RB to each radio terminal in the own sector. Also, the control unit 102 sets a modulation method, a code rate, the number of retransmissions, and a communication method such as MIMO (Multiple-Input Multiple-Output) according to the channel quality requested by each radio terminal.

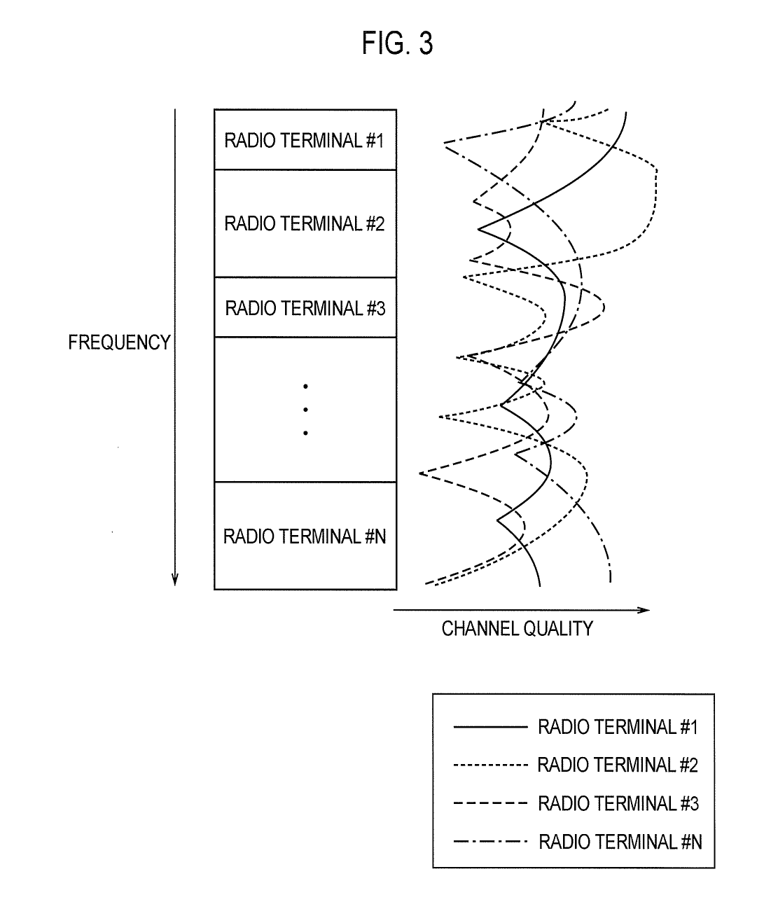

FIG. 3 is a diagram showing an example of PDSCH allocation. FIG. 3 shows an example in which multiple radio terminals #1 to #N are present as radio terminals 2A in the own sector. In FIG. 3, the control unit 102 allocates, to the radio terminal #1 present in the own sector, a PDSCH with a frequency band whose channel quality is equal to or higher than the level requested by the radio terminal #1.

Similarly, the control unit 102 allocates, to the radio terminals #2 to #N present in the own sector, a PDSCH with a frequency band whose channel quality is equal to or higher than the level requested by the radio terminals #2 to #N.

The PDCCH includes various information required to receive user data included in the PDSCH. Thus, when the radio terminal cannot receive the information in the PDCCH, the radio terminal cannot receive the user data in the PDSCH. Therefore, the PDCCH is a very important radio channel.

To be more specific, the PDCCH includes various kinds of control information in the downlink radio resource and DCI (Downlink Control Information) for each radio terminal. The DCI for multiple radio terminals can be accommodated in the PDCCH in one TTI (Transmission Time Interval).

The number of repetitions of repetitively accommodating the DCI for one radio terminal in the PDCCH in one TTI is referred to as an aggregation level (AL).

The control unit 102 determines the AL for the DCI for each radio terminal so that the PDCCH quality satisfies an SINR (Signal to Interference and Noise Ratio) corresponding to the AL. Accordingly, adjustment of the code rate by repetition is realized. Thus, characteristics can be improved. However, as described above, the PDCCH region includes at most three OFDM symbols from the top of the RB. For this reason, if the AL is high, in other words, the larger the number of DCI repetitions, the smaller the number of the radio terminals covered by the DCI that can be accommodated in the PDCCH in one TTI. That is, the AL and the number of the radio terminals covered by the DCI that can be accommodated in the PDCCH in one TTI are in a trade-off relationship.

Moreover, the larger the number of the OFDM symbols in the PDCCH region, the larger the number of the radio terminals covered by the DCI that can be accommodated in the PDCCH in one TTI. However, reduction in the number of the OFDM symbols in the PDSCH region leads to a decrease in the code rate of the PDSCH. Therefore, the AL and the PDSCH reception performance are in a trade-off relationship.

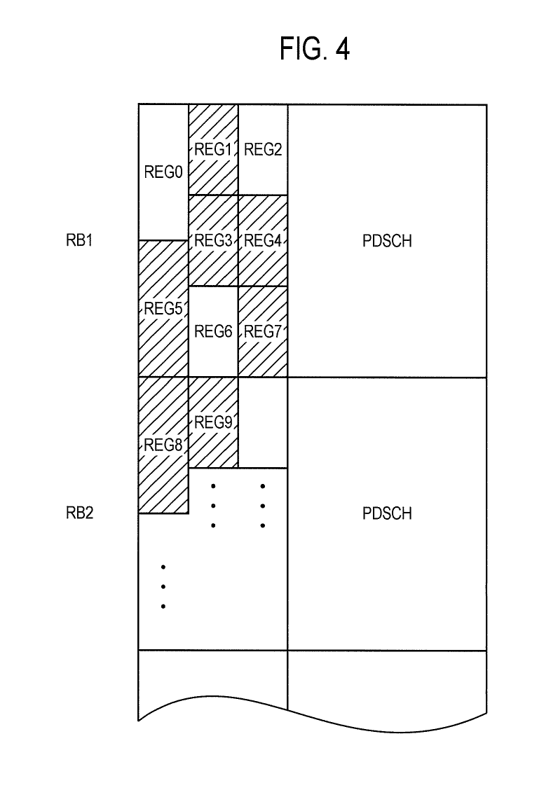

The control unit 102 allocates REGs (Resource Element Groups) in the PDCCH to the radio terminals. FIG. 4 is a diagram showing an example of allocation of the REGs in the PDCCH.

The control unit 102 first performs error-correction coding for each DCI, and arranges the DCI repeated for the number of times equivalent to the AL in a one-dimensional region. In this event, the control unit 102 selects the DCI accommodated location in the one-dimensional region from among a unique value of the DCI, for example, RNTI of the corresponding radio terminal or candidates pseudorandomly determined by the AL. Performing such processing for all the DCI leaves the one-dimensional region having no DCI allocated thereto in a state with no information.

Next, the control unit 102 divides the region in the OFDM symbol as the PDCCH region into REGs. Moreover, the control unit 102 sequentially accommodates the DCI in the REGs at allocation locations from the one having low frequency, the DCI being interleaved using 8 bits in a bit sequence in the one-dimensional region as a unit. Accordingly, the DCI is accommodated pseudorandomly by the REG. As a result, a frequency diversity effect is obtained.

In this embodiment, the control unit 102 estimates the quality (SINR) of the PDCCH corresponding to the own sector prior to the RB allocation to the radio terminals.

As shown in FIG. 2, the control unit 102 includes a W-CQI/SINR conversion unit 152, a SINR corrected value setting unit 154, a SINR estimation unit 158, a PDCCH AL determination unit 160, and a PDCCH allocation processing unit 162 to estimate the quality of the PDCCH corresponding to the own sector and to allocate the PDCCH corresponding to the own sector.

The radio terminal 2A measures W-CQI corresponding to the average quality of the PDSCH included in predetermined downlink radio resource corresponding to the own sector. Then, the radio terminal 2A transmits the measured W-CQI to the radio base station 1A.

The W-CQI/SINR conversion unit 152 in the control unit 102 of the radio base station 1A receives the measured W-CQI corresponding to the own sector from the radio terminal 2A through the antenna 107 and the radio communication unit 105. Then, the W-CQI/SINR conversion unit 152 converts the measured W-CQI corresponding to the own sector into a SINR (reference SINR). Moreover, the W-CQI/SINR conversion unit 152 outputs the reference SINR to the SINR estimation unit 158. The SINR estimation unit 158 stores the reference SINR in the storage unit 103. Furthermore, the SINR estimation unit 158 outputs the reference SINR to the PDCCH AL determination unit 160.

The PDCCH AL determination unit 160 determines the AL in such a manner that the better the reference SINR, the lower the AL.

The PDCCH allocation processing unit 162 allocates the PDCCH in the RB to the radio terminal 2A in the own sector (communication control based on the reference SINR). In this event, the PDCCH allocation processing unit 162 performs processing so that the number of repetitions of repetitively accommodating the DCI for the radio terminal 2A in the PDCCH in one TTI can be equal to the AL determined by the PDCCH AL determination unit 160.

The control unit 102 transmits information on the PDCCH allocated by the PDCCH allocation processing unit 162, for example, information capable of uniquely specifying the PDCCH to the radio terminal 2A through the radio communication unit 105 and the antenna 107.

Therefore, the control unit 102 transmits, using the PDCCH allocated to the radio terminal 2A, the PDSCH allocation information, PUSCH (Physical Uplink Shared CHannel) allocation information and control information including a transmission power control command to the radio terminal 2A through the radio communication unit 105 and the antenna 107.

The radio terminal 2A, when normally receiving the control information transmitted using the PDCCH, performs various controls based on the control information. To be more specific, the radio terminal 2A receives user data transmitted using the allocated PDSCH, and transmits the user data using the allocated PUSCH. Moreover, the radio terminal 2A controls the transmission power according to the transmission power control command. Thereafter, upon receipt of the user data transmitted using the PDSCH, the radio terminal 2A transmits ACK or NACK as a response to the radio base station 1A using the PUSCH.

The SINR corrected value setting unit 154 in the control unit 102 of the radio base station 1A confirms the status of a response from the radio terminal 2A to the control information transmitted by the control unit 102 using the PDCCH. To be more specific, the SINR corrected value setting unit 154 determines that the control information transmitted by the radio terminal 2A using the PDCCH is normally received when receiving ACK or NACK from the radio terminal 2A within a predetermined time after the transmission of the user data by the control unit 102 using the PDSCH. In this case, the SINR corrected value setting unit 154 determines the response status to be normal.

On the other hand, when receiving neither ACK nor NACK even after the predetermined time has passed since the transmission of the user data by the control unit 102 using the PDSCH, the SINR corrected value setting unit 154 determines that the control information transmitted by the radio terminal 2A using the PDCCH is not normally received. In this case, the SINR corrected value setting unit 154 determines the response status not to be normal.

Moreover, the SINR corrected value setting unit 154 determines that the PUSCH allocation information transmitted by the radio terminal 2A using the PDCCH is normally received when the radio terminal 2A is transmitting the user data using the PUSCH allocated to the radio terminal 2A. In this case, the SINR corrected value setting unit 154 determines the response status to be normal.

On the other hand, when the radio terminal 2A is not transmitting the user data using the PUSCH allocated to the radio terminal 2A even after the predetermined time has passed since the transmission of the PUSCH allocation information by the radio base station 1A using the PDCCH, the SINR corrected value setting unit 154 determines that the PUSCH allocation information transmitted by the radio terminal 2A using the PDCCH is not normally received. In this case, the SINR corrected value setting unit 154 determines the response status not to be normal.

Furthermore, the SINR corrected value setting unit 154 measures the received power of the radio signal from the radio terminal 2A. When the received power is within a predetermined range, the SINR corrected value setting unit 154 determines that the received power is within the predetermined range as a result of normal reception of the transmission power control command by the radio terminal 2A and execution of transmission power control according to the transmission power control command. In this case, the SINR corrected value setting unit 154 determines the response status to be normal.

On the other hand, when the received power is outside the predetermined range, the SINR corrected value setting unit 154 determines that the received power is outside the predetermined range since the radio terminal 2A cannot normally receive the transmission power control command and does not perform the transmission power control according to the transmission power control command. In this case, the SINR corrected value setting unit 154 determines the response status not to be normal.

The SINR corrected value setting unit 154 sets a ratio of absolute values of a positive corrected value (increment) and a negative corrected value (decrement), and stores the positive corrected value and negative corrected value according to the ratio in the storage unit 103.

To be more specific, the SINR corrected value setting unit 154 uses a target value (TER: Target Error Rate) of a data error rate of the control information transmitted using the PDCCH to set the ratio of the increment and the decrement so as to satisfy increment/decrement=TER/(1-TER). Here, the TER is stored in the storage unit 103. When the TER is 1% (0.01), for example, increment:decrement is 1:99.

Furthermore, the SINR corrected value setting unit 154 sets the positive corrected value and the negative corrected value so as to satisfy the increment-decrement ratio, and stores the set values in the storage unit 103.

Next, when determining the response status to be normal, the SINR corrected value setting unit 154 selects the positive corrected value stored in the storage unit 103. On the other hand, when determining the response status not to be normal, the SINR corrected value setting unit 154 selects the negative corrected value stored in the storage unit 103.

Thereafter, the SINR corrected value setting unit 154 outputs the selected corrected value to the SINR estimation unit 158.

The SINR estimation unit 158 receives the positive corrected value or negative corrected value from the SINR corrected value setting unit 154, and reads the reference SINR from the storage unit 103. Then, the SINR estimation unit 158 adds the positive corrected value or the negative corrected value to the reference SINR, thereby calculating estimated PDCCH quality (estimated PDCCH-SINR) corresponding to the own sector. Thereafter, the SINR estimation unit 158 stores the estimated PDCCH-SINR in the storage unit 103. The estimated PDCCH-SINR stored is a new reference SINR. Subsequently, the SINR estimation unit 158 outputs the estimated PDCCH-SINR to the PDCCH AL determination unit 160.

As with the above, the PDCCH AL determination unit 160 determines the AL in such a manner that the better the estimated PDCCH-SINR from the SINR estimation unit 158, the lower the AL. The PDCCH allocation processing unit 162 allocates, as with the above, the PDCCH in the RB to the radio terminal 2A in the own sector. In this event, the PDCCH allocation processing unit 162 performs processing so that the number of repetitions when the DCI for the radio terminal 2A is repetitively accommodated in the PDCCH in one TTI corresponds to the AL determined by the PDCCH AL determination unit 160. The information on the allocated PDCCH, for example, information capable of uniquely specifying the PDCCH is transmitted to the radio terminal 2A through the radio communication unit 105 and the antenna 107.

Thereafter, the control unit 102 transmits, using the PDCCH newly allocated to the radio terminal 2A, the PDSCH allocation information, PDSCH allocation information and control information including a transmission power control command to the radio terminal 2A through the radio communication unit 105 and the antenna 107.

### (2) OPERATIONS OF RADIO BASE STATION

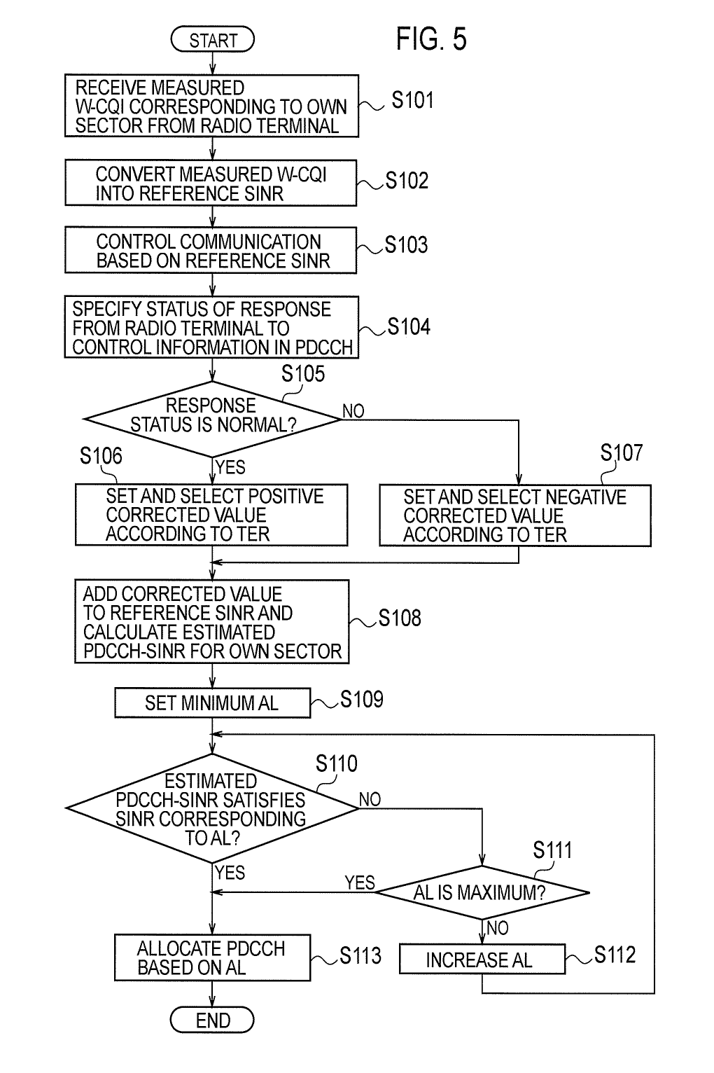

FIG. 5 is a flowchart showing a PDCCH quality estimation operation by the radio base station 1A using a calculation formula.

In Step S101, the control unit 102 in the radio base station 1A receives the measured W-CQI corresponding to the own sector from the radio terminal 2A.

In Step S102, the control unit 102 converts the measured W-CQI into reference SINR.

In Step S103, the control unit 102 performs communication control based on the reference SINR.

In Step S104, the control unit 102 confirms the status of a response from the radio terminal 2A to the control information transmitted to the radio terminal 2A using the PDCCH.

In Step S105, the control unit 102 determines whether or not the confirmed response status is normal.

If the response status is normal, the control unit 102 sets a positive corrected value in accordance with a TER and selects the positive corrected value in Step S106. On the other hand, if the response status is not normal, the control unit 102 sets a negative corrected value in accordance with the TER and selects the negative corrected value in Step S107.

When the positive corrected value is selected in Step S106, the control unit 102 adds the positive corrected value to the reference SINR, thereby calculating estimated PDCCH-SINR in Step S108. On the other hand, when the negative corrected value is selected in Step S107, the control unit 102 adds the negative corrected value to the reference SINR, thereby calculating the estimated PDCCH-SINR in Step S108.

In Step S109, the control unit 102 sets a minimum. AL as an initial value.

In Step S110, the control unit 102 determines whether or not the estimated PDCCH-SINR satisfies the SINR corresponding to the currently set AL.

If the estimated PDCCH-SINR does not satisfy the SINR corresponding to the set AL, the control unit 102 determines whether or not the AL is at its maximum.

If the AL is not at its maximum, the control unit 102 increases the AL in Step S112. Thereafter, the operation of determining whether or not the estimated PDCCH-SINR satisfies the SINR corresponding to the set AL in Step S110 and those subsequent thereto are repeated.

Meanwhile, when determining that the estimated PDCCH-SINR satisfies the SINR corresponding to the set AL in Step S110 or when determining that the AL is at its maximum in Step S111, the control unit 102 allocates the PDCCH to the radio terminal 2A based on the set AL in Step S113.

### (3) ADVANTAGEOUS EFFECTS

In the radio communication system 10 according to this embodiment, the radio base station 1A confirms the status of the response from the radio terminal 2A to the control information transmitted using the PDCCH to the radio terminal 2A, when estimating the quality (SINR) of the PDCCH corresponding to the own sector formed by the radio base station 1A. Furthermore, the radio base station 1A obtains the estimated value (estimated PDCCH-SINR) by correcting the reference SINR in accordance with the response status.

The radio base station 1A performs communication control so that the PDCCH quality meets the required level. In such a case, the status of the response from the radio terminal 2A that is a destination of the control information transmitted using the PDCCH shows whether the PDCCH quality understood at the moment by the radio base station 1A is satisfactory or not. The response status also serves as information useful for the radio base station 1A to estimate the PDCCH quality.

Thus, the PDCCH quality required for communication control can be properly estimated by the radio base station 1A estimating the PDCCH quality in accordance with the status of the response from the radio terminal 2A.

Moreover, the radio base station 1A sets the ratio of the increment and the decrement so as to satisfy increment/decrement=TER/(1-TER), using the TER in the control information transmitted using the PDCCH. Therefore, as the TER becomes lower, that is, as the demand for high communication quality becomes, the ratio of the decrement to the increment becomes larger. Accordingly, as the demand for high communication quality becomes higher, the ratio of the decrement in the case where the response status is not normal to the increment in the case where the response status is normal becomes larger. As a result, the estimated PDCCH-SINR is estimated to be low. Thus, the PDCCH quality can be properly estimated for the demanded communication quality.

### (4) OTHER EMBODIMENTS

As described above, the contents of the present invention have been disclosed through one embodiment of the present invention. However, it should be understood that the present invention is not limited to the description and drawings which constitute a part of this disclosure. From this disclosure, various alternative embodiments, examples and operational technologies will become apparent to those skilled in the art.

While the cells 3A to 3C are divided into multiple sectors in the embodiment described above, the present invention is similarly applicable to the case where the cells are not divided.

Moreover, the control unit 102 may set the corrected values according to the utilization rate of the PDCCH. For example, the control unit 102 sets the corrected values in such a manner that the higher the utilization rate of the PDCCH, the smaller the positive corrected value and the larger the absolute value of the negative corrected value.

As described above, it should be understood that the present invention includes various embodiments and the like which are not described herein. Therefore, a technological scope of the present invention is defined only by items specific to the invention according to claims pertinent based on the foregoing description.

Note that the entire contents of Japanese Patent Application No. 2009-175605 (filed on Jul. 28, 2009) are incorporated herein by reference.

### INDUSTRIAL APPLICABILITY

The communication control method of the present invention is useful as a communication control method since the communication control method of the present invention enables proper estimation of the quality of radio resource.

1. A radio base station forming a predetermined cell or sector and communicating with a radio terminal by allocating radio resource corresponding to the predetermined cell or sector to the radio terminal, the radio resource including control information transmission radio resource and user data transmission radio resource, comprising:
an estimation unit configured to calculate a value obtained by correcting a reference value of the quality of the control information transmission radio resource as an estimated value of the quality of the control information transmission radio resource in accordance with the status of a response from the radio terminal, the response corresponding to control information transmitted to the radio terminal using the control information transmission radio resource.

2. The radio base station according to claim 1, wherein the estimation unit
calculates a value smaller than the reference value as the estimated value of the quality of the control information transmission radio resource if the status of the response from the radio terminal is not normal, and
calculates a value larger than the reference value as the estimated value of the quality of the control information transmission radio resource if the status of the response from the radio terminal is normal.

3. The radio base station according to claim 2, wherein
the estimation unit determines a ratio of increment and decrement from the reference value when obtaining the estimated value, based on a target value of an error rate of data transmitted using the control information transmission radio resource.

4. The radio base station according to any of claims 1 to 3, wherein
the reference value is the quality of the user data transmission radio resource.

5. The radio base station according to any of claims 1 to 3, wherein
the control information is at least any of allocation information of downlink user data transmission radio resource, allocation information of uplink user data transmission radio resource, and a transmission power control command.

6. A communication control method for a radio base station forming a predetermined cell or sector and communicating with a radio terminal by allocating radio resource corresponding to the predetermined cell or sector to the radio terminal, the radio resource including control information transmission radio resource and user data transmission radio resource, the method comprising the step of:
calculating, by the radio base station, a value obtained by correcting a reference value of the quality of the control information transmission radio resource as an estimated value of the quality of the control information transmission radio resource in accordance with the status of a response from the radio terminal, the response corresponding to control information transmitted to the radio terminal using the control information transmission radio resource.
